(19) United States
(12) Patent Application Publication
(10) Pub. No.: US 2010/0038225 A1
(43) Pub. Date: Feb. 18, 2010

(54) Illumination Type Key Sheet and Illumination Type Key

(75) Inventor: Masayuki Furuoya, Tokyo (JP)

Correspondence Address: HEDMAN & COSTIGAN P.C., 1185 AVENUE OF THE AMERICAS, NEW YORK, NY, 10036, US

(73) Assignee: SUNARROW LTD., TOKYO (JP)

(21) Appl. No.: 12/085,624

(22) PCT Filed: May 30, 2006
(86) PCT No.: PCT/JP2006/311174

§ 371 Date: Sep. 17, 2009

(30) Foreign Application Priority Data
Dec. 13, 2005 (JP) 2005-359420

(51) Int. Cl. H01H 13/70

(52) U.S. Cl. 200/314

(57) ABSTRACT

Object of the present invention is to provide an illumination type key sheet and an illumination type key unit thinned, and capable of securing a stroke when a key top is pressed and obtaining a variety of appearances by applying various decoration means.

The present invention is an illumination type key sheet comprising: a key base; and a key top arranged on the key base, wherein an EL sheet having a bulge portion in a position arranging the key top is used for the key base, and the key top has translucency and is arranged on the bulge portion.

### BACKGROUND OF THE INVENTION

1. Field of the Invention

The present invention relates to an illumination type key sheet and an illumination type key unit used for an electronic device such as a portable telephone, a PHS, a portable information terminal (PDA or the like), a portable audio device, a remote controller for home electronic appliances, or a keyboard.

2. Description of the Related Art

An illumination type key sheet (key sheet in which a key top or the like is illuminated by a predetermined light source) used for a portable telephone, a PHS, a portable information terminal (PDA or the like) or the like is mainly configured by disposing a transparent hard resin key top in a rubber elastic substance key pad (key base) of silicone rubber, urethane rubber, TPE or the like.

An illumination type key unit (key unit which includes a predetermined light source to illuminate a key top or the like) mainly includes the illumination type key sheet, a switch section (mainly metal dome) which faces the illumination type key sheet and which is disposed in a position corresponding to the key top arranged on the illumination type key sheet, a substrate mainly having a light source such as a light emitting diode (LED hereinafter) for illuminating the key top or the like, and a presser for pressing the switch section in association with a pressing operation of the key top.

A recent demand for device miniaturization/thinning has led to a request for more thinning of the illumination type key sheet and the illumination type key unit.

To thin the illumination type key sheet and the illumination type key unit, all the components thereof must be thinned. For example, for the key top, as a predetermined strength is necessary even when it is thinned, a metal is more advantageous than a resin. For the light source, use of a so-called EL sheet thinner than the LED and having a plurality of EL elements on a sheet member is more advantageous.

For example, as described in Patent Document 1, an illumination type switch has been disclosed which includes an EL sheet, a semispherical projected part formed on a non-light emitting side face of the EL sheet, and a switch sheet arranged in a position facing the projected part, the EL sheet being formed by stacking a transparent electrode layer, a light emitting layer, an insulating layer, a backside electrode layer, a protective layer on a transparent substrate in this order, and which is characterized in that a material of the projected part is an ultraviolet-ray hardening type resin, and its viscosity is 2 to 40 Pa·s., at a normal temperature (refer to claim 1).

By using the electroluminescence (EL hereinafter) sheet for a light source to illuminate a key top or the like, an illumination type key unit is thinned more than that in the conventional case of using the LED as the light source.

Patent Document 1: JP A 2004-14143

However, the Patent Document 1 only discloses the illumination type switch which uses the flat EL sheet for a key base. When the flat EL sheet descried in the Patent Document 1 is used for the key base, by the EL sheet alone, it is impossible to secure a key stroke for pressing the key top to surely short-circuit a contact by a metal dome or the like.

For example, a case may occur in which the key top or the presser is not lowered to a desired position even when the key top is pressed. Accordingly, in the case of the Patent Document 1, a so-called spacer must be provided between the EL sheet and the switch sheet to secure the key stroke, a structure will become complex, and thinning will be affected.

The use of the metal key top is effective for thinning the illumination type key sheet and the illumination type key unit. However, an appearance is limited to a metal look, and a through-hole of a character, a numeral, a symbol, a picture or the like must be formed in the key top to realize an illumination type which illuminates an object by a light source from the backside. Consequently, there is a problem of monotonous decorations of the key top including a representing method such as characters, symbols or graphics and an appearance.

### SUMMARY OF THE INVENTION

The present invention has been developed with the foregoing problems in mind, and it is an object of the invention to provide an illumination type key sheet and an illumination type key unit thinned, and capable of securing a stroke when a key top is pressed and obtaining a variety of appearances by applying various decoration means.

To solve the problems, an illumination type key sheet of the present invention that includes a key base and a key top arranged on the key base is characterized in that an EL sheet having a bulge portion in a position arranging the key top is used for the key base, and the key top has translucency and is arranged on the bulge portion.

Thinning of the key sheet is realized by employing the EL sheet for the key base. A step can be formed between a peripheral part of the bulge portion and an upper surface of the bulge portion of the key base (EL sheet) by disposing the bulge portion in the key base (EL sheet). As the key top is arranged on the bulge portion, by the step between a key top bottom surface and the peripheral part of the bulge portion, it is possible to secure a stroke when the key top is pressed.

As the key top has translucency, various decoration means can be applied to a backside or a surface of the key top. As a result, it is possible to obtain an illumination type key sheet having a variety of appearances even if it is thin.

The illumination type key sheet of the present invention is characterized in that a presser is disposed on a backside of the bulge portion.

Because of the disposition of the presser on the backside of the bulge portion, pressing of the key top arranged on the bulge portion is accompanied by a downward movement of the presser. When the key sheet is set in a position corresponding to the key top to face a substrate having a clicking operator or the like such as a metal dome, the clicking operator can be pressed to be deformed by pressing the key top. Thus, it is possible to obtain a clear clicking feeling when the key top is operated.

The illumination type key sheet of the present invention is characterized in that a reinforcing member is disposed in the key base.

By disposing the reinforcing member, it is possible to reinforce the key sheet.

The illumination type key sheet of the present invention is characterized in that a translucent film sheet is used for the key base in place of the EL sheet.

By employing the film sheet for the key base, thinning of the key sheet is realized.

An illumination type key unit of the present invention that includes a key base, a key top arranged on the key base, a substrate facing the key base and provided with a switch section in a position corresponding to the key top, and a presser for pressing the switch section in association with a pressing operation of the key top is characterized in that an EL sheet having a bulge portion in a position arranging the key top is used for the key base, the key top has translucency and is arranged on the bulge portion, and a peripheral part of the bulge portion of the key base is fixed to or abuts on the substrate, directly or indirectly.

By employing the EL sheet for the key base, thinning of the key sheet is realized. As the key base (EL sheet) has the bulge portion, a step can be formed between a peripheral part and an upper surface of the bulge portion of the key base (EL sheet). As the key top is arranged on the bulge portion, by the step between a key top bottom surface and the peripheral part of the bulge portion, it is possible to secure a stroke when the key top is pressed.

As the key top has translucency, various decoration means are applied to a backside or a surface of the key top. As a result, it is possible to obtain an illumination type key unit having a variety of appearances even if it is thin.

The illumination type key unit of the present invention is characterized in that one end of the presser is fixed to or abuts on a backside of the bulge portion, and the other end is fixed to or abuts on the switch section.

As one end of the presser is fixed to or abuts on the backside of the bulge portion, and the other end is fixed to or abuts on the switch section, the presser is present without any space between the backside of the bulge portion and the switch section. As a result, with no space, the illumination type key unit is thinned more.

The illumination type key unit of the present invention is characterized in that a reinforcing member is disposed in the key base, and the reinforcing member is fixed to or abuts on the substrate.

By disposing the reinforcing member, it is possible to reinforce the key sheet.

The illumination type key unit of the present invention is characterized in that a translucent film sheet is used for the key base in place of the EL sheet, and an EL sheet is arranged on a surface of the substrate.

By employing the film sheet for the key base, thinning of the key sheet is realized. Further, as the EL sheet is arranged on the surface of the substrate, it can be thinned more than that of an illumination type key unit which uses an LED as a light source.

According to the present invention, the “bulge portion” of the key base (EL sheet or film sheet) may be formed before the illumination type key unit is assembled or at the time of assembling the illumination type key unit. For example, the formation at the assembling time means formation when a predetermined part of the EL sheet is directly or indirectly fixed to the substrate.

According to the present invention, even when a predetermined component is disposed on the substrate, the entire body is represented as a substrate including this component.

According to the present invention, even when a predetermined component is disposed on the switch section, the entire body is represented as a switch section including this component.

According to the present invention, it is possible to provide the illumination type key sheet and the illumination type key unit thinned, and capable of securing a stroke when the key top is pressed and obtaining a variety of appearances by applying various decoration means.

### BRIEF DESCRIPTION OF THE DRAWINGS

FIG. 1 is an exploded perspective view showing an example of an illumination type key unit constituted of an illumination type key sheet and a substrate according to the present invention;

FIG. 2 is an expanded sectional view of an EL sheet;

FIG. 3 is a surface perspective view of the illumination type key sheet;

FIG. 4 is a backside perspective view of the illumination type key sheet;

FIG. 5 is a perspective view of a portable telephone;

FIG. 6 is a backside perspective view of the illumination type key sheet when no reinforcing member is disposed;

FIG. 7 is an expanded sectional view of the illumination type key unit when a reinforcing member is disposed in the EL sheet;

FIG. 8 is an expanded sectional view of the illumination type key unit when no reinforcing member is disposed in the EL sheet;

FIG. 9 is an expanded sectional view of the illumination type key unit when no reinforcing member is disposed in the EL sheet; and

FIG. 10 is an expanded sectional view of the illumination type key unit when a film sheet is used for a key base.

### DESCRIPTION OF THE PREFERRED EMBODIMENTS

The preferred embodiments of the present invention will be described with reference to the accompanying drawings. Similar components or equivalents are denoted by similar reference numerals, and will be described. When there are a plurality of similar or roughly similar components in the drawings, some parts are denoted by reference numerals.

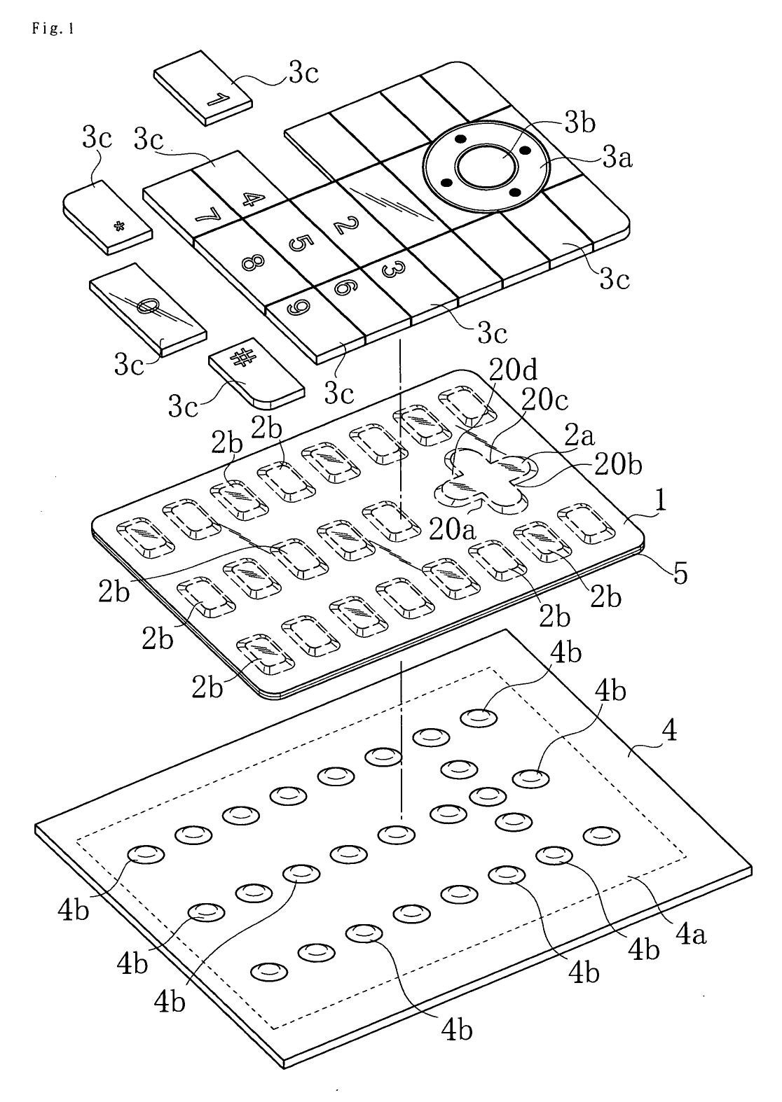

FIG. 1 is an exploded perspective view showing an example of an illumination type key unit constituted of an illumination type key sheet and a substrate according to the present invention. The key sheet of the present invention includes an EL sheet 1 which is a key base, and a plurality of key tops 3 arranged (fixed) on the EL sheet. This key sheet is arranged on the substrate to constitute the key unit.

The plurality of key tops 3 (generic term of a ring key top 3a, an establishment key top 3b, and another key top 3c, similar hereinafter) are arranged (fixed by transparent glue or adhesive) on predetermined positions of a surface of the key base realized by the EL sheet 1.

A bulge portion 2 (generic term of bulge portions 2a, 2b, similar hereinafter) of a predetermined shape is disposed in a predetermined position of the EL sheet 1. For example, the bulge portion 2 has a predetermined roughly flat shape (see FIG. 1).

Each key top 3 is arranged on the bulge portion 2. A substrate 4 has a metal dome 4b in a position corresponding to the key top 3. In other words, the key top 3, the bulge portion 2 and the metal dome 4b correspond to one another in positional relation.

The EL sheet 1 faces the substrate 4, and an area other than the bulge portion 2 including a peripheral part of the bulge portion 2 is fixed to or abuts on the substrate 4, directly or indirectly (indirectly in FIG. 1).

The substrate 4 has a thin sheet-like film 4a (so-called dome sheet) stuck to its surface to fix the metal dome 4b. In FIG. 1, the film 4a is indicated by a dotted line. The substrate 4 includes a mounted electronic device or circuit (not shown), a contact short-circuited by the metal dome 4b, and the like.

The film 4a is made of polyethylene terephthalate (PET hereinafter), polycarbonate (PC hereinafter), or the like.

Elastic deformation of the metal dome 4b short-circuits the contact set on the substrate 4 immediately below the metal dome, thereby enabling an electric switching operation. As a pressing stroke of the illumination type key unit can be secured by elastically deforming the metal dome 4b, operability is enhanced. By a restoring force of the elastic deformation, a clicking feeling can be improved more.

The metal dome 4b can be changed to another switch section. As the switch section, there is available another clicking operator such as a polydome or the like for generating a clicking feeling, a mechanical switch component such as a microswitch, or the like. A case in which the switch section is realized by the metal dome 4b will be described below. Needless to say, in the description below, the metal dome 4b can be changed to the above switch section as occasion demands.

The key top 3 is made of a translucent material such as a colorless or colored translucent resin, various glasses, or the like. A character, a numeral, a symbol, a picture or the like is represented in the surface or the bottom surface of the key top 3 by a penetrated character or another method.

The key top 3 is illuminated by a light emitted from the EL sheet 1, whereby the character, the numeral, the symbol, the picture or the like in the surface or the bottom surface of the key top can be recognized. When the key top is seen from the surface, in the case of the penetrated character, a light emitted from the EL sheet 1 is transmitted from the character, the numeral, the symbol, the picture or the like, whereby the character, the numeral, the symbol, the picture or the like can be recognized. In other cases, for example, the light emitted from the EL sheet 1 is transmitted from a part other than the character, the numeral, the symbol, the picture or the like, whereby the character, the numeral, the symbol, the picture or the like can be recognized.

Because of the arrangement of the key top 3 in the EL sheet 1, the key top 3 is illuminated by the light emitted from the EL sheet 1. Thus, no light irregularity or shadow of the presser that occurs when the key top 3 is illuminated from below the key base by using an LED or the like is generated, enabling clearer illumination of the key top 3.

By using the EL sheet 1, as this EL sheet is thin, and serves also as the key base, it can be made thinner than that when the LED or the like is used as a light source. As the key top has translucency, a conventionally available key top excellent in decoration can be directly used.

The EL sheet 1 is prepared by disposing an EL layer (including protective layer when necessary) on a transparent substrate constituted of a thin sheet-like resin film. The transparent substrate may be colorless or colored. This is properly decided according to a color of a light to be applied. A reinforcing member 5 is disposed in the EL sheet 1 (key base).

Referring to FIG. 2, an example of the EL sheet 1 will be described below. FIG. 2 is an expanded sectional view of the EL sheet 1.

The EL sheet 1 is prepared by forming an EL layer 1a on a transparent substrate 1b. This EL layer 1a is formed by stacking a transparent electrode layer 1c, a light emitting layer 1d, an insulating layer 1e, a backside electrode layer 1f, and a protective layer 1g in this order. A transparent electrode and a backside electrode are connected to a power source (not shown).

In FIG. 2, a key top 3c having a printed layer 10 printed on its bottom surface is arranged (fixed) on a surface (light emitting surface side) of the EL sheet 1 by a glue, an adhesive tape or an adhesive (reference numeral 7). The glue, the adhesive tape or the adhesive (reference numeral 7) that is used must be translucent to illuminate the key top 3c. A presser 6 is fixed to the protective layer 1g (backside).

The transparent substrate 1b is realized by a transparent film made of, e.g., PET, PC or the like of about 75 μm.

The transparent electrode layer 1c is formed on the transparent substrate 1b by vapor deposition, printing or the like, for example, by using iridium tin oxide (ITO hereinafter).

The light emitting layer 1d is formed on the transparent electrode layer 1c by printing, for example, by using a light emitting ink. For a phosphor of the light emitting ink, for example, an inorganic material such as zinc sulfide (ZnS) or the like doped with copper, or an organic material such as a diamine or the like is used. For example, when the zinc sulfide is used for the phosphor, the light emitting ink is produced by mixing and stirring a fluorocarbon resin binder prepared by dissolving a copolymer of vinylidene fluoride and 6-propylene fluoride in a methyl ethyl ketone solvent, and the phosphor. The light emitting layer 1d is formed by printing this light emitting ink on the transparent electrode layer 1c and then heating and drying it by means such as a screen printing method or the like.

For example, the insulating layer 1e is formed on the light emitting layer 1d by means similar to that of the light emitting layer 1d. An ink for forming the insulating layer 1e is produced by mixing and stirring, e.g., a high dielectric substance made of barium titanate (baTiO₃) with the fluorocarbon resin binder.

The backside electrode 1f is formed by printing a carbon ink on the insulating layer 1e and heating and drying it. This carbon ink is produced by mixing, e.g., carbon powders with polyester which is a binder. The carbon ink may be produced by mixing, e.g., carbon powders, silver powders, and copper powders with polyester which is a binder.

Lastly, the protective layer 1g is formed on the backside electrode 1f by printing. The protective layer 1g may be made of polyester, polyimide, polyvinyl chloride or the like having electrical insulation. The materials and the forming method of the transparent electrode layer 1c, the light emitting layer 1d, the insulating layer 1e, the backside electrode 1f, and the protective layer 1g can be changed as occasion demands.

The layer constituting the EL layer 1a can be changed as occasion demands. An insulating layer may be formed between the transparent electrode layer 1c and the light emitting layer 1d. A coat ink material may be used in place of the transparent substrate 1b. In other words, the EL sheet 1 may be formed by printing the coat ink material on a predetermined base material, or the like, forming an EL layer 1a thereon, and then peeling the EL sheet 1 from the predetermined base material. A noise buffer layer may be formed on the protective layer 1g.

A light emitting part of the EL sheet 1 may be the entire EL sheet 1, or limited to a desired part (e.g., part necessary for illuminating the key top 3, such as an upper surface of the bulge portion 2 having the key top 3 disposed therein). By limiting the light emitting part of the EL sheet 1 to the desired part, it is possible to prevent extra leakage of a light. An emitted light color can be changed for each light emitting part. In this case, an emitted light color of the key top 3 can be changed for each key, and a light can be emitted by a color which varies among a character, a numeral, a symbol, a picture and the like on the same key.

When the light emitting part of the EL sheet 1 is limited to the desired part, the light emitting layer 1d is formed on the desired part alone by screen printing or the like. By an area of this light emitting layer 1d, the light emitting part can be limited to the desired part. The light emitting part may be limited to a desired area by the area for forming the electrodes 1c, 1f. The EL layer 1a of the EL sheet 1 may be formed in a desired area alone.

When the light emitting layer 1d is formed on a full surface of the transparent substrate, or the like, to prevent extra leakage of a light from a part other than a part necessary for illuminating the key top 3, a light shielding layer may be formed as a part of the EL sheet 1 in a desired area of the EL sheet 1.

Returning to FIG. 1, the shapes and the number of bulge portions 2 of the key base (EL sheet 1) can be changed as occasion demands. The bulge portion 2a corresponding to the ring key top 3a or the establishment key top 3b may be formed into a roughly cross shape or a circular shape as shown in FIG. 1. Independent bulge portions 2 (5 in FIG. 1) may be disposed corresponding to the metal domes 4b (switch sections) pressed in association with the operations of the ring key top 3a and the establishment key top 3b.

The bulge portion 2b corresponding to the other key top may be formed into a roughly rectangular shape or a circular shape as shown in FIG. 1. In place of disposing the independent bulge portions 2 corresponding to the metal domes 4b pressed in association with the operation of the key top 3c as shown in FIG. 1, a plurality of key tops may be arranged on one bulge portion 2b.

In the case of the roughly cross shape of the bulge portion 2a shown in FIG. 1, peripheral parts 20a to 20d of the bulge portion 2a become pressers when the establishment key top 3b is pressed. Thus, it is possible to prevent a movement of the ring key top 3a influenced by the pressing of the establishment key top 3b.

Any shape of the bulge portion 2 can be employed as long as a step can be formed between a bottom end of the key top and a periphery of the bulge portion 2 on the EL sheet 1. In other words, any shape of the bulge portion 2 can be employed as long as a stroke can be secured by this step when the key top 3 is pressed, and the key top 3 is lowered to a desired position by pressing the key top 3.

When the flat EL sheet is used for the key base, and the key tops are independent of one another, to prevent an inconvenience that when a predetermined key top is pressed, the EL sheet is deformed around this key top, and the key top present in a periphery of this key top is affected to move (interference problem between the key tops), it is advised to provide bulge portions 2 so that a stroke can be secured when the key top 3 is pressed, and an area (peripheral part of the bulge portion 2) between the adjacent bulge portions 2 can be fixed to or abut on the substrate or the like. Accordingly, when the key top 3 is pressed, the area (peripheral part of the bulge portion 2) between the bulge portions 2 which is fixed to or abuts on the substrate or the like becomes a presser, and the key tops on the adjacent bulge portions 2 become independent of each other, whereby the interference problem between the key tops, or the like can be solved.

The bulge portion 2 is molded after the EL sheet 1 is formed. The EL layer 1a may be formed on the bulge portion 2 after the bulge portion 2 is formed on the transparent substrate 1b. The El sheet 1 may be formed by forming an EL layer 1a in a predetermined base having a bulge portion 2, peeling the EL layer 1a from the base, and sticking the EL layer 1a to the transparent substrate 1b. A method of forming a bulge portion 2 is decided as occasion demands.

The bulge portion 2 may be formed beforehand as described above. However, it may be formed when an illumination type key unit is assembled.

As the EL sheet 1 has the bulge portion 2, a step can be disposed between the peripheral part of the bulge portion 2 of the EL sheet 1 and the upper surface of the bulge portion 2. As the key top 3 is arranged on the bulge portion 2, a stroke can be secured by a step between the key top bottom surface and the peripheral part of the bulge portion 2 when the key top is pressed. By securing the stroke, it is possible to lower the key top to a desired position when the key top is pressed.

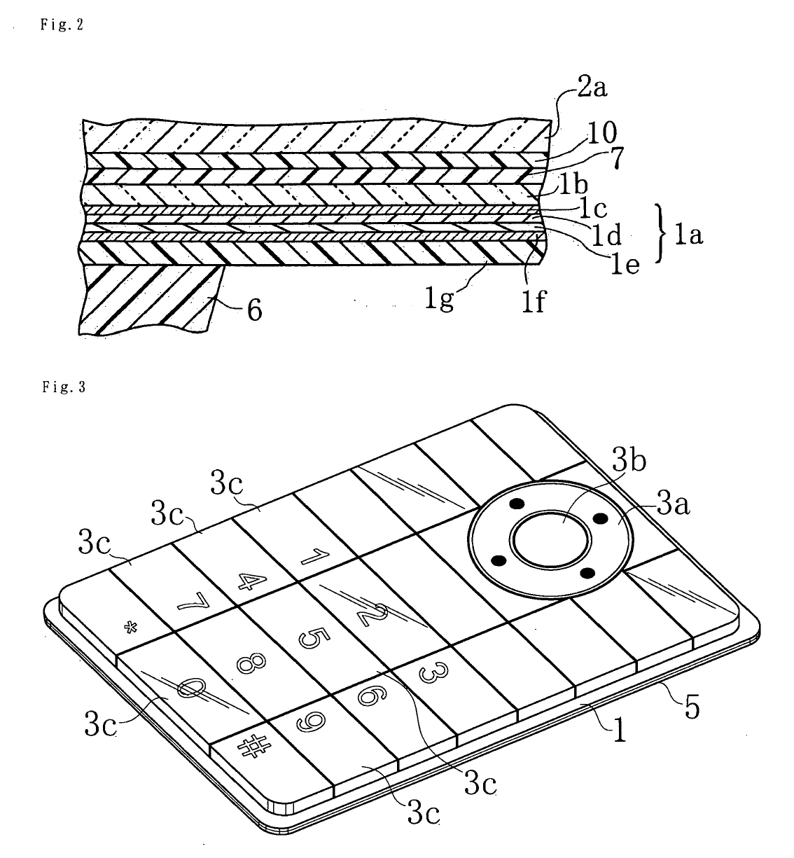

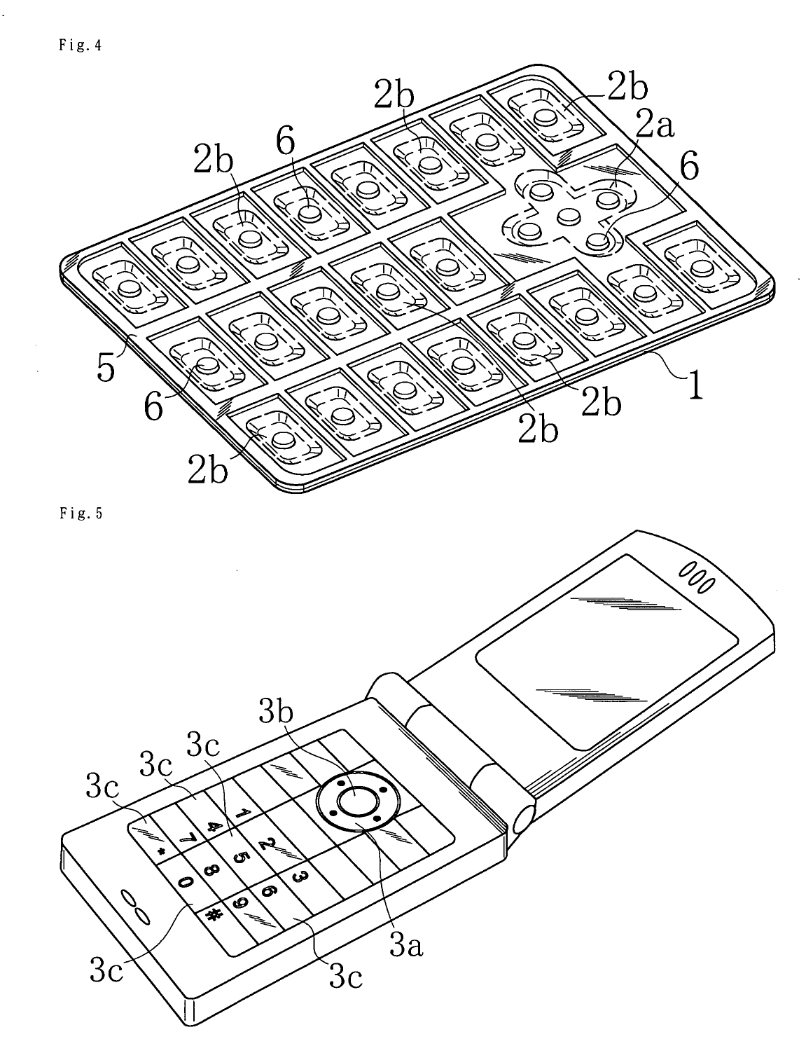

FIG. 3 is a surface perspective view of the illumination type key sheet. FIG. 4 is a backside perspective view of the illumination type key sheet. FIG. 5 is a perspective view of a portable telephone.

As shown in FIG. 3, the ring key top 3a, the establishment key top 3b, and the other key top 3c are arranged on predetermined positions of the surface of the EL sheet 1.

As shown in FIG. 4, a reinforcing member 5 is disposed in the backside of the EL sheet 1. For the reinforcing member 5, a highly rigid material is suitable for the purpose of suppressing distortion of the EL sheet 1. For such a material, a hard resin or metal such as a polycarbonate resin, a polyurethane resin, or a silicone resin can be used.

The reinforcing member 5 reinforces the EL sheet 1. A shape may be a lattice shape shown in FIG. 3, and changed as occasion demands. The reinforcing member 5 can be disposed in at least a part of an area other than the bulge portion 2 in the backside of the EL sheet 1. Under a condition that it is not affected by a movement of a presser 6 described below, the reinforcing member 5 may be disposed to cover a part of the bulge portion 2. By disposing the reinforcing member 5 in the EL sheet 1, it is possible to secure rigidity necessary for suppressing distortion of the EL sheet 1 and obtaining shape stability.

When the illumination type key unit is incorporated in a portable telephone or the like in an exposed state of the key top 3 from an operation opening having no partition bar (see FIG. 5), and when the EL sheet 1 directly abuts on the substrate 4, with the EL sheet 1 alone, as the EL sheet 1 is thin and easily deformed, the key top 3 may float from the operation opening. However, by disposing the reinforcing member, it is possible to prevent the floating of the key top 3 from the operation opening.

Returning to FIG. 4, the EL sheet 1 includes the presser 6 disposed to press the metal dome 4b in association with the pressing operation of the key top 3. This presser 6 is disposed in the backside of the bulge portion 2a. The presser 6 may be arranged on the metal dome 4b side. The metal dome 4b is pressed by the presser 6, whereby a surer clicking feeling can be obtained.

The presser 6 can be formed into a rectangular parallelepiped shape, a circular cylinder shape, a semispherical shape, or the like. A radius (longitudinal or horizontal length in the case of the rectangular parallelepiped shape) of the presser 6 is set normally smaller than a diameter of the metal dome. Accordingly, a surer clicking feeling can be obtained.

A material and a forming method of the presser 6 can be decided as occasion demands. For example, for the material, silicone rubber, various thermosetting resins, a thermoplastic resin, a UV cured resin, or the like can be used. For the forming method, a method using a dispenser (liquid material feeder), a method using gravure printing, and the like are available. When the EL sheet 1 is used for the key base, the presser 6 does not need to have translucency as a light source for illumination is above the presser 6. When a film sheet is used for the key base as described below, the presser 6 should preferably have translucency.

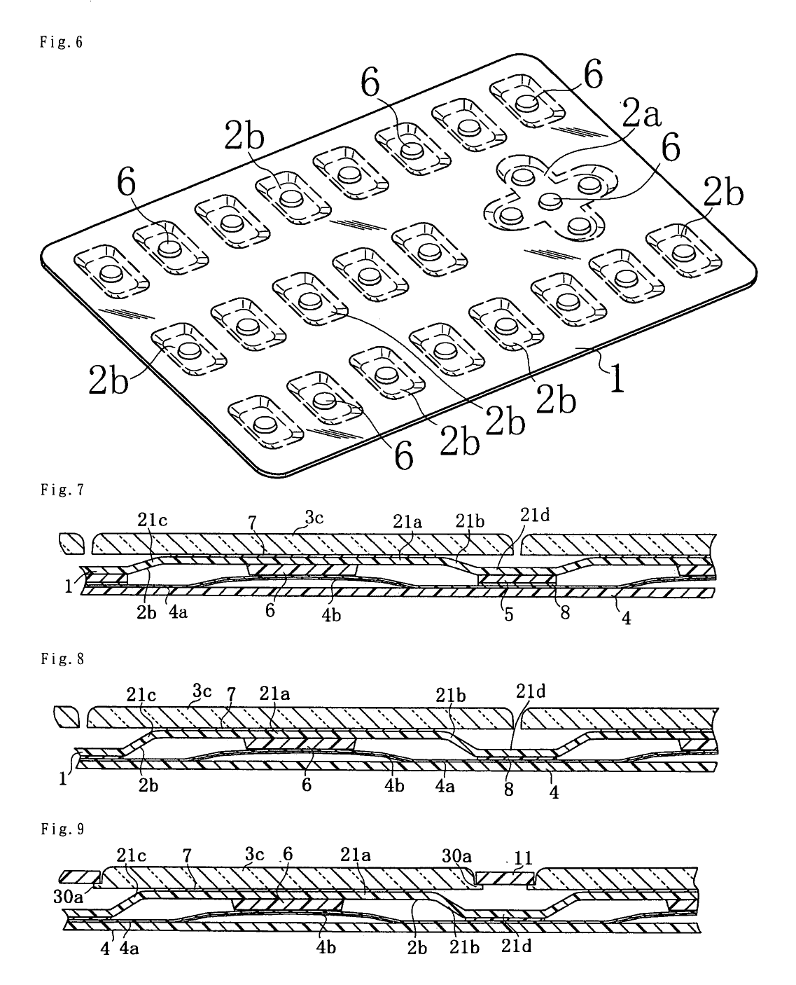

It may not be necessary to provide a reinforcing member 5 in the EL sheet 1. FIG. 6 is a backside perspective view of the illumination type key sheet when no reinforcing member 5 is disposed.

When the illumination type key unit is incorporated into a portable telephone or the like in an exposed state of the key top 3 from the operation opening having a partition bar, a flange or the like of the key top 3 abuts on the partition bar even by the EL sheet 1 alone, thereby preventing floating of the key top 3 from the operation opening. Accordingly, no reinforcing member 5 needs to be disposed in the EL sheet 1.

In this case, however, suppression of distortion of the EL sheet 1 or the like is enabled by disposing a reinforcing member 5. This is particularly effective when the EL sheet 1 directly abuts on the substrate 4. When the EL sheet 1 is directly fixed to the substrate 4, no reinforcing member 5 may be necessary because of reinforcement by the substrate 4. Description of the presser 6 and the other components will be omitted as they are similar to those described above with reference to FIG. 4 in which the reinforcing member 5 is disposed.

A relation among the key top, the EL sheet, the substrate, and the presser will be described in detail with reference to FIG. 7. FIG. 7 is an expanded sectional view of the illumination type key unit when a reinforcing member is disposed in the EL sheet.

A key top 3c is arranged on the bulge portion 2b. In this case, the key top 3c is fixed to an upper surface 21a of the bulge portion 2b by a glue, an adhesive tape, or an adhesive (reference numeral 7). The glue, the adhesive tape, or the adhesive that is used should have translucency to illuminate the key top 3c.

The reinforcing member 5 is disposed in a peripheral part 21d of the bulge portion 2b of the EL sheet 1 (fixed by a glue, an adhesive tape, or an adhesive) as described above. This reinforcing member 5 is fixed to the substrate 4 by using a glue, an adhesive tape, or an adhesive (reference number 8) (at least a part needs to be fixed to prevent shifting of the EL sheet 1 from the substrate 4).

The reinforcing member 5 may abut on the substrate 4. In this case, when the illumination type key unit is incorporated into a portable telephone or the like, it is advised to fix the EL sheet 1 and the substrate 4 to a case of the portable telephone or the like having the key unit incorporated therein so as to prevent shifting thereof. The EL sheet 1 and the substrate 4 may be fixed by a component other than the reinforcing member 5 to prevent shifting thereof.

In FIG. 7, the peripheral part 21d of the bulge portion 2b of the EL sheet 1 abuts on or is fixed to the substrate 4, indirectly. The glue, the adhesive tape, or the adhesive (reference number 8) does not need to have translucency as it is not required. In reality, the reinforcing member 5 abuts on or is fixed to a film 4a of the substrate 4. According to the present invention, even when a predetermined component (film 4a) is disposed on the substrate 4, it is represented as a substrate 4 as a whole.

One end of the presser 6 is fixed (disposed) to the backside of the bulge portion 2b. The other end abuts on the metal dome 4b. In reality, the film 4a abuts on or is fixed to the presser 6. However, according to the present invention, even when the metal dome 4b is covered with a predetermined component (film 4a or the like), representation of “it abuts on (is fixed to) the metal dome 4b” rather than representation of “it abuts on (is fixed to) a predetermined sheet” is used.

According to the present invention, even when a predetermined component (film 4a or the like) is disposed on the metal dome 4b, it is represented by a metal dome 4b.

Both ends of the presser 6 may be fixed to or abut on the backside of the bulge portion 2b and the metal dome 4b. The presser 6 may be disposed on the metal dome 4b side (one end is fixed) to abut (the other end) on the backside of the bulge portion 2.

The presser 6 is present without any space between the backside of the bulge portion 2b and the metal dome 4b, whereby the key unit can be thinned more. A restoring force of the metal dome 4b (clicking operator) after its elastic deformation can be used for a force to return the pressed key top 3c to its original position.

When the presser 6 is fixed to the metal dome 4b or the backside of the bulge portion 2b, a side opposed to the fixed side does not need to abut on the backside of the bulge portion 2b or the metal dome 4b.

The bulge portion 2b includes slopes 21b, 21c and an upper surface 21a. As described above, the key top 3c is arranged on the upper surface 21a. Because of the slopes 21b, 21c of the bulge portion 2b, a step is generated between a bottom surface of the key top 3c and the peripheral part 21d of the bulge portion 2b. This step generates a stroke when the key top 3c is pressed.

The step between the bottom surface of the key top 3c and the peripheral part 21d of the bulge portion 2b only needs to have a height equal to that of the metal dome 4b, i.e., a distance to press and deform the metal dome 4b by the presser 6, to short-circuit a contact by the metal dome 4b, and to generate a clicking feeling. Accordingly, when it is pressed, the key top 3c can be moved to a desired position to obtain a clicking feeling. This step is adjusted based on a height of the bulge portion 2 (step between the upper surface 21a and the area 21d), a thickness of the presser 6, a thickness of the reinforcing member 5, or the like.

When it is pressed, the key top 3c moves downward. In this case, because of deformation of the slopes 21b, 21c and the step between the bottom surface of the key top 3c and the peripheral part 21d of the bulge portion 2b, the key top 3c can smoothly move downward.

The pressing operation of the key top 3c is accompanied by a downward movement of the presser 6. Then, the presser 6 presses and deforms the metal dome 4b to generate a clicking feeling.

As a stroke can be secured by the step between the bottom surface of the key top 3c and the peripheral part 21d of the bulge portion 2b, and the EL sheet 1 is indirectly fixed to or indirectly abuts on the substrate 4 in the peripheral part 21d (area between adjacent bulge portions 2) of the bulge portion 2b, the key top 3c can be moved to a desired position when the key top 3c is pressed. As the fixed or abutted peripheral part 21d becomes a presser to deform the slopes 21b, 21c of the EL sheet 1, it is possible to prevent a movement of an adjacent key top 3c.

Accordingly, in the case in which the flat EL sheet is used for the key base, and the key tops are independent of one another, it is possible to prevent an inconvenience that when a predetermined key top is pressed, the EL sheet is deformed around this key top, and the key top present in the periphery of this key top is affected to move (interference problem between the key tops). It is possible to eliminate a difficulty of short-circuiting the contact only by a movement of a single key top caused by the movement of the key top present in the periphery of the pressed key top.

When the reinforcing member 5 is fixed to the substrate 4 (during key unit assembling), the bulge portion 2 may be formed. For example, by fixing the reinforcing member 5 disposed in the flat EL sheet 1 to the substrate 4, a predetermined area of the EL sheet 1 is bulged by an amount equal to heights of the presser 6 and the metal dome 4b. Accordingly, the bulge portion 2 may be disposed.

A relation among the key top, the EL sheet, the substrate, and the presser when no reinforcing member is disposed in the EL sheet 1 will be described in detail with reference to FIG. 8. FIG. 8 is an expanded sectional view of the illumination type key unit when no reinforcing member is disposed in the EL sheet.

A difference between FIGS. 7 and 8 is that no reinforcing member 5 is disposed in the substrate 4 in FIG. 8. In other words, the EL sheet 1 directly abuts on or is directly fixed to the substrate 4 in the peripheral part 21d of the bulge portion 2b of the EL sheet 1. Other components are similar to those described above with reference to FIG. 7.

When no reinforcing member 5 is disposed in the EL sheet 1, i.e., when the EL sheet 1 directly abuts on or is directly fixed to the substrate 4 in the peripheral part 21d of the bulge portion 2b of the EL sheet 1, a large step can be set between the bottom surface of the key top 3 and the peripheral part 21d of the bulge portion 2b. Accordingly, it is possible to secure a sufficient stroke when the key top 3 is pressed.

As a stroke can be secured by the step between the bottom surface of the key top 3c and the peripheral part 21d of the bulge portion 2b, and the EL sheet 1 is directly fixed to or directly abuts on the substrate 4 in the peripheral part 21d (area between adjacent bulge portions 2) of the bulge portion 2b, the key top 3c can be moved to a desired position when the key top 3c is pressed. As the fixed or abutted peripheral part 21d becomes a presser to deform the slopes 21b, 21c of the EL sheet 1, it is possible to prevent a movement of an adjacent key top 3c.

Accordingly, in the case in which the flat EL sheet is used for the key base, and the key tops are independent of one another, it is possible to prevent an inconvenience that when a predetermined key top is pressed, the EL sheet is deformed around this key top, and the key top present in the periphery of this key top is affected to move (interference problem between the key tops). It is possible to eliminate a difficulty of short-circuiting the contact only by a movement of a single key top caused by the movement of the key top present in the periphery of the pressed key top.

When a reinforcing member 5 is disposed in the EL sheet 1, i.e., when the El sheet 1 indirectly abuts on or is indirectly fixed to the substrate 4 (through the reinforcing member 5) in at least a part of the area 21d other than the bulge portion 2b of the El sheet 1, the slopes 21b and 21c are reduced in inclination. Thus, a height of the bulge portion 2b can be reduced, and deterioration of the bulge portion 2 caused by the pressing operation of the key top 3 can be reduced.

A relation among the key top, the EL sheet, the substrate, and the presser in another example when no reinforcing member is disposed in the EL sheet 1 will be described in detail with reference to FIG. 9. FIG. 9 is an expanded sectional view of the illumination type key unit when no reinforcing member is disposed in the EL sheet.

A difference between FIGS. 8 and 9 is that the illumination type key unit of FIG. 9 is incorporated in a portable telephone or the like in an exposed state of the key top 3 from the operation opening having a partition bar.

In FIG. 9, a flange 30a of the key top 3 abuts on a partition bar 11. Accordingly, as floating of the key top 3 from the operation opening is prevented, no reinforcing member 5 needs to be disposed in the EL sheet 1. As the partition bar 11 is present, the key top 3c may be disposed in a manner of abutting on the upper surface 21a of the bulge portion 2b.

The reinforcing member 5 may be properly disposed for the purpose of suppressing distortion of the EL sheet 1 and preventing deterioration of the EL sheet 1 as described above. Other components are similar to those described above with reference to FIGS. 7 and 8.

A film sheet may be substituted for the EL sheet 1 of the key base. For example, the film sheet is realized by a translucent film sheet made of PC, PET or the like of about 75 μm. Description of a shape or the like will be omitted as it is similar to the EL sheet 1 (film sheet 12 is substituted for the EL sheet 1).

When the film sheet is substituted for the EL sheet 1, a light source for illuminating the key top is necessary. This is realized by an EL sheet. This EL sheet is arranged on the substrate 4.

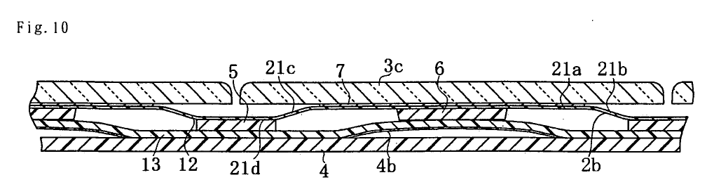

This case will be described with reference to FIG. 10. FIG. 10 is an expanded sectional view of the illumination type key unit-when a film sheet is used for a key base.

As shown in FIG. 10, an EL sheet 13 is arranged on a surface of the substrate 4 in place of the film 4a (used for fixing the metal dome 4b on the substrate 4). The EL sheet 13 is first molded, and then fixed to the surface of the substrate 4 by a glue, an adhesive tape or an adhesive (not shown). An EL layer may be directly formed as the EL sheet 13 in the surface of the substrate 4 by the vapor deposition, printing or the like.

A light emitting part of the EL sheet 13 may be the entire part thereof, or limited to a desired part (e.g., part necessary for illuminating the key top 3, such as a position corresponding to the key top 3, or on the metal dome 4b). By limiting the light emitting part of the EL sheet 13 to the desired part, it is possible to prevent extra leakage of a light. A color of an emitted light can be changed for each light emitting part. In this case, it is possible to change an emitted light color of the key top 3 for each key, and to emit a light whose color varies among a character, a numeral, a symbol, a picture and the like even on the same key.

When the light emitting part of the EL sheet 13 is limited to the desired part, a light emitting layer is formed in the desired part by screen printing or the like. The light emitting part can be limited to the desired part by an area of this light emitting layer. A light emitting part may be formed in a desired area by an area for forming an electrode. An EL layer of the El sheet 13 may be formed in a desired area alone.

The EL sheet 13 may include a through-hole formed in a predetermined position so that, for example, the presser 6 can directly abut on or be directly fixed to the metal dome 4b. When the through-hole is disposed in the predetermined position of the EL sheet 13, and the presser 6 directly abuts on or is directly fixed to the metal dome 4b, a clicking feeling is directly transmitted to the presser 6, whereby a good clicking feeling can be obtained.

Components, a forming method, and the like of the EL sheet 13 are similar to those of the foregoing EL sheet 1, and thus description thereof will be omitted.

A reinforcing member 5 similar to that described above is disposed (fixed by a glue, an adhesive tape, an adhesive or the like) in a peripheral part 21d of a bulge portion 2b of a film sheet 12, and this reinforcing member 5 is fixed to the substrate 4 by using a glue, an adhesive tape or an adhesive (at least a part only needs to be fixed to prevent shifting of the film sheet 12 from the substrate 4).

The reinforcing member 5 may abut on the substrate 4. In this case, when this illumination type key unit is incorporated into a portable telephone or the like, it is advised to fix the unit to a case of the portable telephone or the like in which it is incorporated so that shifting of the film sheet 12 and the substrate 4 can be prevented. To prevent shifting of the film sheet 12 and the substrate 4, they may be fixed to each other by a part other than the reinforcing member 5.

In other words, the film sheet 12 indirectly abuts on or is indirectly fixed to the substrate 4 in the peripheral part 21d of the bulge portion 2b of the film sheet 12.

It has been described that “the film sheet 12 indirectly abuts on or is indirectly fixed to the substrate 4”. In reality, however, in FIG. 10, the film sheet 12 indirectly abuts on or is indirectly fixed to the EL sheet 13. As described above, even when there is a predetermined component (EL sheet 13) disposed on the substrate 4, it is represented as a substrate as a whole.

One end of the presser 6 is fixed (disposed) to a backside of the bulge portion 2b. The other end abuts on the metal dome 4b. In reality, the EL sheet 13 abuts on or is fixed to the presser 6. According to the present invention, however, even when the metal dome 4b is covered with a predetermined component (EL sheet 13 or the like), it is represented not as “it abuts on (is fixed to) a predetermined sheet” but as “it abuts on (is fixed to) the metal dome 4b”. As described above, even when a predetermined component (EL sheet or the like) is disposed on the metal dome 4b, it is represented as a metal dome 4b.

No reinforcing member may be used similarly to the case in which the EL sheet 1 is used. This is similar to that described above with reference to FIG. 8 or 9. Needless to say, the EL sheet 1 is replaced by the film sheet 12, and the EL sheet 13 is arranged on the substrate 4.

By using the film sheet 12 for the key base and the EL sheet 13 as a light source, it is possible to realize a thin illumination type key sheet and a thin illumination type key unit.

The conventional technology that uses silicone rubber or the like for the key base has had a limit in thinning due to easy tearing and other problems. However, by using the EL sheet or the film sheet for the key base, the limit is overcome to enable more thinning.

What is claimed is:

1. An illumination type key sheet comprising:
a key base; and
a key top arranged on the key base,
wherein an EL sheet having a bulge portion in a position arranging the key top is used for the key base, and the key top has translucency and is arranged on the bulge portion.

2. The illumination type key sheet according to claim 1, wherein a presser is disposed on a backside of the bulge portion.

3. The illumination type key sheet according to claim 1 or 2, wherein a reinforcing member is disposed in the key base.

4. The illumination type key sheet according to any one of claims 1 to 3, wherein a translucent film sheet is used for the key base in place of the EL sheet.

5. An illumination type key unit comprising:
a key base;
a key top arranged on the key base;
a substrate facing the key base and provided with a switch section in a position corresponding to the key top; and
a presser for pressing the switch section in association with a pressing operation of the key top,
wherein an EL sheet having a bulge portion in a position arranging the key top is used for the key base, the key top has translucency and is arranged on the bulge portion, and a peripheral part of the bulge portion of the key base is fixed to or abuts on the substrate, directly or indirectly.

6. The illumination type key unit according to claim 5, wherein one end of the presser is fixed to or abuts on a backside of the bulge portion, and the other end is fixed to or abuts on the switch section.

7. The illumination type key unit according to claim 5 or 6, wherein a reinforcing member is disposed in the key base, and the reinforcing member is fixed to or abuts on the substrate.

8. The illumination type key unit according to any one of claims 5 to 7, wherein a translucent film sheet is used for the key base in place of the EL sheet, and an EL sheet is arranged on a surface of the substrate.
